(19) United States
(12) Patent Application Publication
(10) Pub. No.: US 2008/0279738 A1
(43) Pub. Date: Nov. 13, 2008

(54) Zeolite Catalyst for the Simultaneous Removal of Carbon Monoxide and Hydrocarbons From Oxygen-Rich Exhaust Gases and Processes for the Manufacture Thereof

(75) Inventors: Wolfgang Strehlau, Liederbach im Taunus (DE); Olga Gerlach, Ludwigshafen (DE); Jurgen Maier, Mannheim (DE); Tamara Gabriel, Bruchsal (DE)

Correspondence Address: PATENT GROUP 2N;JONES DAY, NORTH POINT, 901 LAKESIDE AVENUE, CLEVELAND, OH, 44114, US

(73) Assignee: HTE AKTIENGESELLSCHAFT THE HIGH THROUGHPUT EXPERIM, Heidelberg (DE)

(21) Appl. No.: 11/664,194

(22) PCT Filed: Oct. 4, 2005
(86) PCT No.: PCT/EP05/10679

§ 371 Date: Jul. 19, 2007

(30) Foreign Application Priority Data
Oct. 4, 2004 (DE) 10 2004 048 247.0

(51) Int. Cl. B01D 53/94; B01J 21/02; B01J 21/06; B01J 23/14

(52) U.S. Cl. 423/213.5; 502/74; 502/73; 502/61; 502/66

(57) ABSTRACT

Catalyst containing tin oxide, palladium and one or more zeolites as carrier oxide, in which the zeolite preferably has a silicon/aluminum ratio of >4. Said catalyst is utilized for the removal of harmful substances from lean combustion engines and exhaust airs, preferably for the simultaneous removal of carbon monoxide and hydrocarbons and sooty particles from diesel exhaust gases.

The present invention relates to a zeolite catalyst for the simultaneous removal of carbon monoxide and hydrocarbons from oxygen-rich exhaust gases, for example from diesel engines, lean Otto engines and stationary sources. The catalyst contains at least one zeolite that is loaded with palladium and tin oxide, preferably being present on the catalyst in a roentgenographically amorphous or nanoparticular form. Preferably, the zeolite has a silicon/aluminum ratio of >4. Optionally, said catalyst can contain further metals of the platinum group as well as oxides of indium, gallium, iron, alkali metals, earth alkali metals and rare earth elements. The invention also relates to a process for the manufacture of the catalyst as well as to a process for the purification of exhaust gases by using the novel catalyst. The catalyst has a high conversion performance for carbon monoxide and hydrocarbons, a highly thermal stability and a good sulfur resistance.

The important harmful substances from the exhaust gas of diesel engines are carbon monoxide (CO), unburned hydrocarbons (HC) such as paraffins, olefins, aldehydes, aromatic compounds, as well as nitric oxides (NOₓ), sulfur dioxide (SO₂) and sooty particles which contain carbon both in the solid form and in the form of the so-called “volatile organic fraction” (VOF). Further, diesel exhaust gas also contains oxygen in a concentration which is, dependent on the working point, around 1.5 to 15%.

The harmful substances which are emitted from lean Otto engines, for example from Otto engines that directly inject, consist substantially of CO, HC, NOₓ, and SO₂. Compared to CO and HC, the oxygen is present in a stoichiometrical surplus.

In the following, diesel engines and lean Otto engines are termed as “lean combustion engines”.

Both industrial exhaust gases and exhaust gases from domestic fuel also can contain unburned hydrocarbons and carbon monoxide.

The term “oxygen-rich exhaust gas” encompasses an exhaust gas, in which oxygen is present in a stoichiometrical surplus compared to the oxidizable harmful substances such as CO and HC.

Oxidation catalysts are employed for the removal of harmful substances from said exhaust gases. Said catalysts function to remove both carbon monoxide and hydrocarbons by oxidation, in which, in the ideal case, water and carbon dioxide are generated. Additionally, also soot can be removed by oxidation, in which also water and carbon dioxide are formed.

U.S. Pat. No. 5,911,961 discloses an oxidation catalyst made from a metallically or ceramically monolithic body with a catalytically active coating of two components. As first component, Pt and/or Pd and at least one of the oxides of W, Sb, Mo, Ni, V, Mn, Fe, Bi, Co, Zn and earth alkali are employed on a first fire-resistant (refractory) oxide, such as TiO₂ or ZrO₂, in which the second component consists of a second refractory oxide, such as Al₂O₃, SiO₂, TiO₂, ZrO₂, SiO₂—Al₂O₃, Al₂O₃—ZrO₂, Al₂O₃—TiO₂, SiO₂—ZrO₂, TiO₂—ZrO₂, zeolites.

EP 1 129 764 A1 discloses an oxidation catalyst which contains at least one zeolite and additionally one of the carrier oxides aluminum oxide, silicon oxide, titanium oxide and aluminum silicate and one of the noble metals Pt, Pd, Rh, Ir, Au and Ag.

U.S. Pat. No. 6,274,107 B1 discloses an oxidation catalyst which contains cerium oxide, optionally aluminum oxide and a zeolite, for example β-zeolite. Furthermore, the zeolite can also be doped with the metals of the platinum group. The described catalyst promotes the oxidation of CO, HC and of the hydrocarbons which are condensed on the soot particles.

EP 0 432 534 B2 discloses a continuously working oxidation catalyst having a high conversion performance for hydrocarbons and carbon monoxide in the low temperature ranges. The catalyst consists of vanadium compounds and metals of the platinum group which are applied on finely divided aluminum oxide, titanium oxide, silicon oxide, zeolite as well as the mixtures thereof. According to the tables 2 and 3 of said document, the values for the 50% conversion of CO and HC (T₅₀ values which are also termed as light-off temperature) for the freshly pre-pared catalysts are above a temperature of 200° C.

EP 0 566 878 A1 discloses an oxidation catalyst having a high conversion performance for hydrocarbons and carbon monoxide and inhibited oxidation properties towards nitric oxide and sulfur oxide. The catalyst contains a monolithic body which consists of an activity-promoting dispersion coating made from finely divided metal oxides such as aluminum oxide, titanium oxide, silicon oxide, zeolite, or the mixtures thereof, as carrier and a catalytically active component. As active components, the metals of the platinum group are employed which are doped with vanadium or an oxidic vanadium compound. According to table 1 of said document, the light-off temperatures (T₅₀) in the light-off tests at diesel engines are between 195° C. and 220° C. for the CO oxidation for the freshly prepared catalysts and between 210° C. and 222° C. for the HC oxidation.

WO 03/024589 A1 claims a catalyst for the purification of diesel exhaust gases which is characterized in that at least one noble metal is deposited onto a non-porous silicon dioxide which, for example, can be gained by means of flame hydrolysis form silicon tetrachloride. The catalysts which are produced according to said process exhibit a very good sulfur tolerance.

Catalysts are also known that utilize tin oxide as catalytically active component.

U.S. Pat. No. 6,132,694 discloses a catalyst for the oxidation of volatile hydrocarbons which consists of a noble metal such as Pt, Pd, Au, Ag and Rh, and a metal oxide having more than one stable oxidation state, and which includes at least tin oxide. The metal oxide can be doped with small amounts of oxides of the transition metals. Other oxides are not mentioned. The catalyst is produced in a manner that preferably a monolithic body is loaded with several layers of tin oxide. Then, the noble metal is applied onto the tin oxide. According to the examples, particularly good results are obtained if the noble metal is platinum and the oxide having more than one stable oxidation state is tin oxide.

U.S. Pat. No. 4,117,082 discloses oxidation catalysts, where tin oxide is used as carrier for the active components Pt, Pd, Rh, Ir and Ru. Also other carrier oxides such as Al₂O₃ or SiO₂ and magnesia can be used. The catalysts are produced in a manner that firstly the active component is deposited onto the tin oxide. Then, in a second step, the obtained solid particles are deposited from an aqueous suspension onto the carrier oxide. So, a catalyst is obtained which consists of a carrier oxide which is coated with tin oxide, in which the tin oxide is coated with the active components.

U.S. Pat. No. 4,855,274, U.S. Pat. No. 4,912,082 and U.S. Pat. No. 4,991,181 disclose catalysts for the oxidation of carbon monoxide to carbon dioxide. Said catalysts consist of silica gel that is coated with tin oxide. Then, in a second reaction step, a metal of the platinum group, preferably platinum, is applied onto the tin oxide layer in the form of an aqueous solution. So, a catalyst is obtained which consists of a carrier oxide which is coated with tin oxide which in turn is coated with platinum or a platinum-containing compound.

As a rule, the technically employed catalysts contain platinum as the active component. In the following, the advantages and drawbacks of such catalysts are briefly discussed.

Besides the oxidation of CO and HC, also the formation of NO₂ from NO and oxygen is promoted. Dependent on the total functionality of the oxidation catalyst, this can be an advantage or a drawback.

In conjunction with soot filters, the formation of NO₂ at the diesel oxidation catalyst may be desired, because the NO₂ contributes to the degradation of soot, i.e. contributes to the oxidation thereof to carbon dioxide and water. Such a combination of diesel oxidation catalyst and soot filter is also termed as CRT system (continuously regenerating trap) and, for example, is disclosed in the patents EP 835 684 and U.S. Pat. No. 6,516,611.

Without the use of soot filters in the exhaust gas line, the formation of NO₂ is undesired because NO₂ being emitted yields a strongly unpleasant odor.

Because of the chemical and physical properties of platinum, the platinum-containing catalysts have considerable drawbacks after highly thermal stress.

The admixture of zeolite for the formulation of diesel oxidation catalysts is already known from the EP 0 800 856. Zeolites have the capability of adsorbing hydrocarbons at low exhaust gas temperatures, and to desorb said gases if the light-off temperature of the catalyst is reached.

As disclosed in the EP 1 129 764 A1, the effectiveness of the zeolites may be based on their capability of “cracking” long-chain hydrocarbons being present in the exhaust gas, i.e. to dissect said hydrocarbons into smaller fragments which can easier oxidized by the noble metal.

The exhaust gas temperatures of effective diesel engines which frequently are provided with turbo chargers, predominantly are run in a temperature range between 100 and 350° C., whereas regulations are given for the operation points of motor vehicles by the NED cycles (new European driving cycle). During the operation under partial load, the exhaust gas temperatures are in the range between 120 and 250° C. During the operation under full load, the temperatures reach as a maximum 650 to 700° C. On one hand, oxidation catalysts with low light-off temperatures (T₅₀ values) are required, and, on the other hand, a highly thermal stability is required in order to avoid a drastic activation loss during the operation under fall load. Furthermore, it has to be noted that unburned hydrocarbons accumulate on the catalyst and can ignite there, so that local catalyst temperatures can be far beyond the temperature of 700° C. Temperature peaks up to 1000° C. can be achieved. Said temperature peaks can lead to a damage of the oxidation catalysts. Then, particularly in the low temperature range, no significant conversion of harmful substances is achieved by oxidation.

Further, different soot filters were developed for the reduction of the particle emission from the diesel exhaust gas which, for example, are described in the patent application WO 02/26379 A1 and in U.S. Pat. No. 6,516,611 B1. During the combustion of the soot which accumulates on the particulate filters, carbon monoxide can be released which, by means of catalytically active coatings for soot filters, can be converted to carbon dioxide. Appropriate coatings can also be termed as oxidation catalysts. For the conversion of the soot into harmless CO₂ and water, the accumulated soot can be burned up in intervals, in which the necessary temperature for the burn-up of the soot can be produced for example by engine-internal methods. The burn-up of the soot, however, is associated with a high release of heat which can lead to a deactivation of the platinum-containing oxidation catalysts which are applied on the filters.

Therefore, for the compensation of thermal damages, platinum-containing oxidation catalysts for exhaust gases from diesel passenger cars are mostly provided with high quantities of platinum. Said quantities are typically in the range of from 2.1 to 4.6 g/l (60-130 g/ft³). For example, up to 9 g platinum are used for a 2 liter catalyst. The use of high quantities of platinum is an essential expense factor for the treatment of exhaust gases of diesel vehicles. The reduction of the platinum portion in the catalyst is of highly economical interest.

In conjunction with the introduction of diesel particulate filters, besides the low light-off temperature and the required highly thermal stability, further requirements for oxidation catalysts become apparent which are characterized subsequently.

For example, an oxidation catalyst can be installed in an upstream position of the diesel particulate filter. Then, it is possible to increase the concentration of hydrocarbons at the oxidation catalyst and to use the heat which is released when burning the hydrocarbons in order to initiate the combustion of the soot on the diesel particulate filter which is installed in the downstream position. Alternatively or also additionally, the diesel particulate filter itself can be coated with the oxidation catalyst. Thereby, the additional coating of the diesel particulate filter has the function to oxidize the carbon monoxide which is released during the combustion of the soot to carbon dioxide. In case of highly thermal stability and simultaneously high activity of such a coating, in some applications, the oxidation catalyst which additionally is installed in an upstream position, could be totally set aside. Both functionalities of oxidation catalysts that are discussed here in conjunction with the diesel particulate filters, require a highly thermal stability of the catalysts whereby platinum-containing catalysts may have drawbacks as mentioned before. Another problem for the purification of diesel exhaust gases relates to the presence of sulfur in the diesel fuel. Sulfur can be deposited onto the carrier oxide and can contribute to a deactivation of the oxidation catalysts by means of catalytic poisoning. Platinum-containing oxidation catalysts have an advantageously good resistance towards sulfur. In the known catalyst formulations, platinum has proved to be clearly superior over the other metals of the platinum group such as rhodium, palladium or iridium. The use of palladium as solely catalytically noble metal component for the detoxification of lean combustion engines was tested in numerous technical and scientific operations, however always failed until now due to the absence of sulfur resistance of appropriate catalysts (see e.g. Jordan K. Lampert, M. Shajahan Kazi, Robert J. Farrauto: Applied Catalysis B: Environmental 14 (1197) 211-223; Patrick Gelin, Michel Primet: Applied Catalysis B: Enviroumental 39 (2202) 1-37).

The object of the invention was to develop a novel catalyst for the removal of harmful substances from exhaust gases of lean combustion engines and exhaust air which can oxidize CO and HC to CO₂ and water with a high low temperature activity, and which simultaneously has an improved thermal stability with respect to the catalysts of the prior art as well as a good sulfur resistance. Together with the improvement of the performance properties of the catalyst to be developed, a way should be found to decrease the manufacturing costs compared to the previously applied catalysts.

This object could be achieved with a catalyst that contains tin oxide, palladium and a zeolite as carrier oxide.

Thus, the object of the invention is a catalyst containing tin oxide, palladium and a carrier oxide, characterized in that the carrier oxide comprises one or more zeolites.

Optionally, said catalyst may contain further metals of the platinum group or may contain promoters.

The freshly prepared catalyst and the catalyst after aging with sulfur at low temperature exhibit a comparable efficiency for the CO and HC oxidation compared to the catalysts of the prior art. However, said catalyst considerably outperforms said efficiency after thermally aging at high temperature. Therefore, said catalyst is thermally very stable and simultaneously has a good sulfur resistance.

Furthermore, the catalyst can either be prepared without the expensive noble metal platinum, respectively platinum can be reduced in its quantity in a manner that all in all a reduction of the material costs as well as a reduction of the manufacturing costs is possible compared to the catalysts of the prior art.

When preparing catalysts without platinum or when using only low quantities of platinum, the catalysts according to the invention practically have no tendency to the oxidation of NO to NO₂ by means of air oxygen, so that unpleasant odors can be minimized.

Compared to the catalysts of the prior art, the novel catalyst has both technical and economical advantages.

The term “tin oxide” which is used in the following includes all possible oxides and suboxides of the tin.

The term “palladium” includes both the element and the possible oxides and suboxides.

A “carrier oxide” is a zeolite which is thermally stable and which has a large surface.

A “zeolite” is a microporous, silicon- and aluminum-containing oxide. As a rule, said oxide has the structure of a cage and/or a channel. Such zeolites are known from the prior art. Furthermore, the term also includes that one or more zeolites can be employed as carrier oxide.

According to the reference book Römpp (Lexikon Chemie, 10. Edition, 1999, Georg Thieme Verlag Stuttgart New York, pp. 5053-5055), such zeolites can be characterized by the formula M_{2/z}.Al₂O₃.xSiO₂.yH₂O. Therein, M is a monovalent or bivalent metal (alkali metal ion or earth alkali metal ion), H or NH₄, and z is the valence of the cation. In general, x is between 1.8 and 12 and y is between 0 and approximately 8.

Naturally occurring zeolites are, for example, zeolites of the strand type (such as natrolite, laumontite, mordenite, thomsonite), zeolites of the sheet type (heulandite, stilbite, philipsite, harmotome), zeolites of the cube type (such as faujasite, gmelinite, chabasite, offretite).

Also the synthetic manufacture is known. For example, SiO₂-containing compounds such as water glass or silica sols can be reacted with Al₂O₃-containing compounds such as alumina hydroxide, aluminates or kaolines in the presence of alkali metal hydroxides.

From the high number of zeolites, predominantly the technically employed zeolites are utilized, such as the zeolites of the faujasite type or pentasile type, mordenite or beta zeolite (also known as zeolite-β).

Preferably, zeolites are employed having a silicon/aluminum ratio of >4. Particularly preferred are zeolites having a silicon/aluminum ratio of >7.

Particularly preferred are hydrothermally stable zeolites with a Si/Al ratio of >7.

Further particularly well suited zeolites are Y zeolite, DAY zeolite (dealuminated Y zeolite), USY zeolite (ultrastabilized Y zeolite), ZSM-5, mordenite and β-zeolite.

Particularly advantageous is the use of β-zeolite.

The mentioned zeolites can be used either in the pure form or as mixtures, in which also the use of zeolites is possible comprising the forms which were obtained by ion exchange or other treatment of doped zeolites.

Preferably, the zeolite can be present in the sodium form, ammonium form or H form. Furthermore, it is also possible to convert the sodium, ammonium or H form by means of impregnation with metal salts and oxides or by means of ion exchange into another ionic form. As an example, the conversion of Na Y zeolite into RE zeolite (RE=rare earth element) by means of ion exchange in aqueous rare earth element chloride solution is mentioned.

A particularly well catalytic activity with respect to the reduction of hydrocarbons in exhaust gases is achieved thereby that a zeolite is employed that is doped with iron.

For example, in the manufacture according to the invention, at least one zeolite can be employed as an iron-exchanged zeolite. Alternatively, in a subsequent reaction step, the iron can be contacted with the zeolite in the form of a suitable precursor.

For example, water soluble compounds of the iron such as iron nitrate, iron acetate or iron oxalate as well as the iron oxides are considered as precursors of the iron.

Also, the iron can be admixed to the tin precursor solution as a water-soluble pre-cursor and can be impregnated onto the zeolite together with the tin.

Further examples for zeolites that are usable for the invention, however the present invention is not limited to, are the following commercially available zeolites: Mordenit HSZ®-900 (Company Tosoh), Ferrierit HSZ@-700 (Company Tosoh), HSZ@-900 (Tosoh), USY HSZ@-300 (Company Tosoh), ZSM-5 SiO₂/Al₂O₃ 25-30 (Company Grace Davison), ZSM-5 SiO₂/Al₂O₃ 50-55 (Company Grace Davison), β-Zeolith HBEA-25 (Company Süd-Chemie), HBEA-150 (Company Süd-Chemie), CP 814C (Company Zeolyst), CP 814E (Company Zeolyst), Zeocat FM-8/25H (Company Zeochem), Zeocat PB/H (Company Zeochem).

Preferably, the zeolites have a BET surface of more than 100 m²/g. Preferably, they still have a large BET surface after high temperature pollution.

Additionally to the zeolite, in particular additionally to the mentioned zeolites, the catalyst according to the invention may also contain admixtures of one or more non-zeolitic oxides. Said oxides are preferably utilized as a binder. In the following, said oxides are termed as binder oxide. Particularly for the coating of carrier bodies, the addition of binder oxides is frequently necessary in order to ensure a sufficient coatability of the shaped body with the zeolite and to ensure a sufficiently mechanical stability of the zeolite on the shaped body.

Basically, as binder oxides all thermally resistant oxides and binder oxides based on Al₂O₃, SiO₂, Al₂O₃/SiO₂-mixed oxide, rare earth element oxide-doped Al₂O₃, TiO₂, BaSO₄, Ce₂O₃, Ce₂O₃/ZrO₂-mixed oxide, Fe₂O₃, Mn₃O₄, as well as mixtures thereof, are usable.

Particularly the binder oxides based on Al₂O₃ and SiO₂ or Al₂O₃ or SiO₂, however particularly based on Al₂O₃ and SiO₂ in combination with zeolite have very good properties. Particularly, said properties apply the coatability of shaped bodies as well as the activity of the catalysts for the oxidation of carbon monoxide and hydrocarbons.

Another object of the invention is also a process for the manufacture of the catalyst according to the invention.

The catalyst is produced by a process which comprises the step (i):
(i) contacting tin and palladium compounds with a carrier oxide, wherein the carrier oxide comprises one or more zeolites.

The term “tin and palladium compounds” of the step (i) stands for all tin and palladium compounds which can be suspended in a liquid medium and/or are completely or at least partially soluble in said medium. Such compounds are also termed as precursors.

Preferably, tin and palladium compounds are employed which are completely or at least partially soluble in said liquid medium.

Preferably, the liquid medium is water.

Preferably, tin and palladium salts are applied. For example, salts are the salts of inorganic acids, such as halides or nitrates, or salts of organic acids, such as formiates, acetates, hexanoates, tartrates or oxalates. The use of complex compounds of tin and palladium is also possible. For example, palladium can be applied in the form of soluble ammonium complexes.

Preferably, tin oxalate being dissolved in water is applied as tin compound, in which the solubility can be further increased by addition of nitric acid.

If the application of palladium and tin compound is performed simultaneously, then, preferably, the palladium is employed in the form of its nitrate.

Furthermore, the employed tin and palladium compounds can be subjected to a chemical treatment. For example, said compounds can be treated with acids as described above for tin oxalate. Also the addition of complexing agents is possible. By means of said treatment, for example, said compounds can be converted into a particularly good solubility condition which is advantageous for the intended processing.

For the manufacture of the catalysts, a process is preferred, where tin and palladium compounds are employed being free as possible from chloride, because a later release of chloride-containing compounds from the catalyst can lead to severe damages of the exhaust gas facilities.

“Contacting” means that the tin and palladium compounds are mutually applied onto the carrier oxide in a suspended or preferably in a dissolved form either simultaneously or sequentially.

For the manufacture of the catalyst, all embodiments are preferred which generally have proved of value within the catalyst research, in particular “washcoat” and/or “honeycomb” and “powder or pellet” technologies. Exemplarily, the embodiments (α), (β), (γ), (δ) are discussed below.

(α) It is possible to proceed in a manner wherein the binder oxide is mutually provided with the at least one zeolite in an aqueous medium, is ground to particle sizes of several micrometers and is then mutually applied onto a ceramically or metallically shaped body. Naturally, it is also possible, to firstly grind the binder oxide, and to admix the zeolite after the termination of the grinding process. Subsequently, the shaped body is dunked into the binder oxide/zeolite suspension, in which said shaped body is loaded with both the binder oxide and the zeolite, i.e. said shaped body is impregnated. After the thermal treatment such as drying or calcination, a shaped body is obtained being coated with a mixture of binder oxide and zeolite. Then, the coated shaped body is dunked into the solution of tin and palladium compounds, whereby the zeolite and the binder oxide are loaded respectively coated. Then, it is dried and preferably calcined. The process can be repeated until the desired loading amount is achieved.

(β) However, it is also possible to add the dissolved tin and palladium compounds to the binder oxide/zeolite suspension, and then to dunk the shaped body into the suspension, to load, i.e. to impregnate, to dry and to calcine. The process can be repeated as often until the desired loading amount is achieved.

(γ) Furthermore, it is possible firstly to impregnate a zeolite respectively a mixture of zeolite and binder oxide with the dissolved tin and palladium compounds, in which the used total volume of the impregnation solution respectively the impregnation solutions is below the maximum adsorption capacity of liquid of the zeolite respectively the zeolite and the binder oxide. In this manner, an impregnated powder can be gained which appears to be dry and which is dried and calcined in a subsequent step. The composite being gained in this manner, can be provided in water and can be ground. Subsequently, the resulting “washcoat” can be applied onto a shaped body.

(δ) It is also possible to add the dissolved tin and palladium compounds to the binder oxide/zeolite suspension, and to subject the suspension to a spray drying process and to a calcination. For example, the catalyst can then be obtained in the form of a powder. Said material can also be used for the coating of shaped bodies, optionally after a grinding-step in an aqueous suspension.

Basically, it is not required to apply the tin and palladium compounds simultaneously onto the zeolite. So, for example, at first the tin compound can be processed according to the above mentioned process routes, whereas the palladium compound, for example, is applied by dunking the shaped body being coated with the washcoat into a solution of the appropriate palladium compound.

All known methods can be used for the loading of the at least one zeolite by means of contacting with the dissolved tin and palladium compounds as well as for the drying and calcination step of the catalyst. Said methods depend on the selected process types, in particular therefrom whether the “washcoat” is applied at first onto a shaped body, or whether a powder process is selected. Said methods comprise processes such as “incipient wetness”, “dunking impregnation”, “spray impregnation”, “spray drying”, “spray calcination” and “rotary calcination”. The confection of the catalyst can also be carried out according to the known methods, for example by means of extruding or by extrusion molding.

Therefore, the catalyst according to the invention is preferably provided as powder, pellets, extrudate, shaped body or as a coated honeycomb body.

Besides the above mentioned methods for the homogeneous dispersion of the catalytically active substances onto the zeolite, that is the soaking of the zeolite with metal salt solutions, the impregnation of the carrier materials with metal salt solutions, the adsorption of metal salts from liquids and the spraying on of solutions, also the application by means of precipitation from solution or the deposition from solutions can be utilized.

Also the application of tin and palladium compounds from a solution is possible.

After the charging of the at least one zeolite with the tin and palladium compounds, a subsequent drying step and, as a rule, a calcination step is carried out. In case of a spray calcination, such as described in the EP 0 957 064 B1, the drying and calcining can practically be carried out in a single process step.

Therefore, the process also includes the step (ii):
(ii) calcining.

Preferably, the calcination step is carried out at a temperature of from 200 to 1000° C., more preferred of from 300° C. to 900° C., in particular of from 400 to 800° C.

By means of the calcination step, the tin salt is decomposed by means of the temperature treatment, and is at least partially converted into tin oxide.

Also the palladium salt can be converted by means of the temperature treatment into its oxides. Also the formation of elementary palladium is possible.

By means of the calcination step, also the mechanical stability of the catalyst is increased.

Besides the above described required components of the catalyst, in the catalyst manufacture or for the treatment thereof, auxiliary materials and/or additives may be added, such as oxides and mixed oxides as additives for the carrier material, binders, fillers, hydrocarbon adsorbers or other adsorbing materials, dopants for the increase of the temperature resistance as well as mixtures of at least two of the before mentioned substances.

Said further components may be inserted into the “washcoat” in a water soluble and/or a water insoluble form before or after the coating process. After the application of all ingredients of the catalyst onto the shaped body, as a rule, the shaped body is dried and calcined.

Components with which the catalyst may be doped, comprise for example further materials of the platinum group, i.e. platinum, rhodium, iridium and ruthenium. Thereby, the term “platinum, rhodium, iridium and ruthenium” comprises both the elements and the oxides.

Therefore, the catalyst is also characterized in that it is doped with one or more metals selected from the group consisting of platinum, rhodium, iridium or ruthenium.

Therefore, the process for the manufacture of the catalyst also includes the step (iii):
(iii) doping the catalyst with one or more compounds selected from the group consisting of platinum, rhodium, iridium or ruthenium.

The compounds from step (iii) can already be added in step (i). However, it is also possible to add said compounds at a moment where the zeolite or the shaped body has already been coated, preferably according to one of the preceding methods (α), (β), (γ) and (δ).

Preferably, water soluble salts of said compounds are applied, for example in the form of the nitrates thereof. For ruthenium, also ruthenium nitrosotrinitrate has proved of value. Preferably, the application is carried out by dunking impregnation as described above. After application of all ingredients of the catalyst, subsequently a drying step and calcination step is carried out.

After the calcining, said metals are present in the catalyst in the form of the elements or of the oxides.

By means of doping with the oxides of indium, gallium, iron, the alkali metals, earth alkali metals, the rare earth elements, or mixtures thereof, a further activity increase of the catalyst may be achieved. Said compounds are also termed as promoters.

The terms “indium oxide”, “gallium oxide”, “alkali metal oxide”, “earth alkali metal oxide” and “rare earth element oxide” include all possible oxides and sub-oxides as well as all possible hydroxides and carbonates.

So, the term “alkali metal oxide” comprises all oxides, suboxides, hydroxides and carbonates of the elements Li, Na, K, Rb and Cs.

The term “earth alkali metal oxide” comprises all oxides, suboxides, hydroxides and carbonates of the elements Mg, Ca, Sr and Ba.

The term “rare earth element oxide” comprises all oxides, suboxides, hydroxides and carbonates of the elements La, Ce, Pr, Nd, Pm, Sm, Eu, Gd, Tb, Dy, Ho, Er, Tm, Yb, Lu, Y and Sc.

If the catalyst according to the invention is manufactured by the addition of promoters, the tin oxide and the promoters can be present either as mixed oxide or, as the case may be, as oxides with “pyrochloric” structure. “Pyrochloric” oxides can be described with the common empirical formula A₂B₂O₇. In dependence from the quantities of tin- and promoter-containing components which are used for the manufacture of the catalyst, dependent on the size of the formation of pyrochloric oxides, said oxides can be present as crystalline tin-containing phase in addition to the above mentioned roentgenographically amorphous tin oxide phase.

Also the addition of boron oxide or phosphorus oxide can be advantageous for the sulfur tolerance of the catalysts.

The term “boron oxide” comprises all oxides, suboxides and hydroxides of the element boron. The term “phosphorus oxide” comprises all oxides, suboxides and hydroxides of the element phosphorus.

Preferably, the boron oxide is impregnated onto the carrier oxide, preferably from an aqueous boric acid, either separately or together with at least one of the above mentioned compounds, i.e. a compound of the tin, platinum or of a promoter. Thereby, said boron oxide is homogeneously dispersed on the surface of the catalyst.

Preferably, the phosphorus oxide is impregnated onto the carrier oxide, preferably from an aqueous phosphoric acid, either separately or together with at least one of the above mentioned compounds, i.e. a compound of the tin, platinum or of a promoter. Thereby, said phosphorus oxide is homogeneously dispersed on the surface of the catalyst.

It is not disclaimed that both boron oxide and phosphorus oxide are added in the manufacture of the catalyst.

Further, the catalyst is also characterized in that it may contain promoters selected from the group consisting of indium oxide, gallium oxide, iron oxide, alkali metal oxide, earth alkali metal oxide and rare earth element oxide.

Therefore, the process for the manufacture of the catalyst includes also the step (iv):
(iv) doping the catalyst with a promoter.

If gallium oxide, indium oxide, iron oxide, alkali metal oxides, earth alkali metal oxides and rare earth element oxides are utilized, preferably said compounds are also applied in the form of compounds being at least partially soluble in water.

Preferably, the promoters are used in the form of the nitrates thereof. For example, in the technical scale, the nitrates of the rare earth elements are accessible by dissolving the carbonates thereof in nitric acid. The use of nitrates is particularly advantageous if the promoters are simultaneously applied onto the carrier oxide together with the nitrate-containing compounds of the tin and of the palladium. Preferably, a process is used for the manufacture of the catalyst, where the starting materials of the promoters are contacted with the zeolite by means of an aqueous medium.

The compounds can be added in step (i). However, it is also possible to add them at a moment, where the zeolite or the shaped body preferably has been coated according to one of the above mentioned methods (α), (β), (δ) and (γ).

It is also possible to add said compounds prior, together or after the compounds of the metals of the platinum group, i.e. platinum, rhodium, iridium and ruthenium.

After the application of the promoters, optionally, in turn a drying and/or calcination step is subsequently carried out.

In the following, the chemical composition of the catalysts according to the invention is disclosed. The weight proportions in % are based on the element mass of tin, palladium or the other elements of the metals of the platinum group and of the promoters, respectively. For the binder oxides as well as for the zeolites, the weight proportions are based on the respective oxidic compounds.

The catalyst contains a total amount of from 10-100% by weight of zeolite based on the total amount of zeolite and binder oxide, wherein a total amount of from 20-90% by weight is preferred.

The catalyst contains a total amount of from 2-50% by weight of tin oxide (calculated as tin) based on the total amount of zeolite and binder oxide, wherein a total amount of from 4-25% by weight of tin oxide is preferred.

The total amount of palladium, platinum, rhodium, iridium and ruthenium based on the total amount of zeolite and binder oxide preferably is of from 0.2-10% by weight. More preferred is a total amount of from 0.4-5% by weight.

The following weight proportions are based on the element masses of the respective elements.

The weight proportion of tin oxide (calculated as tin) to the sum of the weights of palladium, platinum, rhodium, iridium and ruthenium preferably is in a range of from 2:1 to 40:1, wherein a weight proportion in a range of from 4:1 to 30:1 is more preferred. Still more preferred is a weight proportion in a range of from 5:1 to 20:1.

If platinum is additionally employed to palladium, then the weight proportion of palladium to platinum preferably is in a range of from 0.3:1 to 1000:1. More preferred is a range of from 1:1 to 50:1.

If rhodium, ruthenium, iridium or mixtures thereof are employed in place of platinum, then the weight proportion of palladium to rhodium, ruthenium, iridium or a mixture thereof preferably is in a range of from 2.5:1 to 1000:1. More preferred is a range of from 5:1 to 20:1.

If platinum and at least one further metal of the platinum group is additionally employed to palladium, then the weight proportion of palladium to the sum of platinum and the at least one further metal preferably is in the range of from 0.3:1 to 1000:1. More preferred is a range of from 1:1 to 50:1.

If promoters are employed, then the weight proportion of tin oxide (calculated as tin) to the sum of all promoters (calculated as elements) is in a range of from 2:1 to 100:1. More preferred is a range of from 4:1 to 50:1. Still more preferred is a weight proportion in a range of from 5:1 to 35:1.

If boron oxide is employed, then the weight proportion of all employed carrier oxides to boron oxide (calculated as boron) is in a range of from 1:0.00005 to 1:0.2. More preferred is a range of from 1:0.0001 to 1:0.1. Still more preferred is a range of from 1:0.0002 to 1:0.075.

If phosphorus oxide is employed, then the weight proportion of all employed carrier oxides to phosphorus oxide (calculated as P) is in a range of from 1:0.00005 to 1:0.2. More preferred is a range of from 1:0.0001 to 1:0.1. Still more preferred is a range of from 1:0.0002 to 1:0.075.

Preferably, the catalyst has a structure in which macropores exist having ducts which coexist with mesopores and/or micropores.

Tin oxide and palladium and optionally promoters are very homogeneously dispersed on the surface of the nanoparticular carrier oxide, inter alia due to the utilized manufacturing process.

The homogeneity of the dispersion of tin and palladium on the zeolite being used as carrier oxide can be described thereby that preferably
(1) tin and palladium—by consideration of the individual particles—each are dispersed in approximately constant concentrations across the particles of the carrier oxide, and
(2) the concentration ratios—by consideration of the individual particles—of tin oxide to carrier oxide as well as the concentration ratios of tin oxide to palladium are approximately constant on the surface of the particles of the carrier oxide.

Said dispersion also includes that the catalyst, for example, contains mixtures of at least two tin- and palladium-containing carrier oxides on the basis of zeolite which each have different tin and/or palladium concentrations. Further, said dispersion also includes that the catalyst is manufactured according to the process of the gradient coating. In case of a gradient coating, a gradient—for example of the palladium, the tin, of a promoter or boron oxide—for example is adjusted across the length of a honeycomb body being used for the manufacture of the catalyst, as already discussed above.

Preferably, the term “gradient coating” relates to a gradient in the chemical composition.

As a measuring method for the verification of the homogeneity, fundamentally the known REM and EDX methods (scanning electron microscopy/energy disperse X-ray microanalysis) can be used. Because sometimes the assignment of the reflexes for the tin oxide and for the palladium is made difficult by the reflexes which are originated by the zeolite, the sample properties can be analyzed by means of TEM (transmission electron microscopy) respectively by X-ray deflection.

Preferably, the tin oxide being deposited onto the zeolite has a roentgenographically amorphous or nanoparticular form.

Preferably, the palladium is also present in a roentgenographically amorphous or nanoparticular form.

Said properties being advantageous for the catalytic effectiveness can be determined by means of X-ray deflection.

In general, particle sizes can be determined by means of the Scherrer equation from X-ray defection:

Scherrer equation: D=(0,9*λ)/(B cos θ_{B})

Here, “D” is the thickness of a crystallite, “λ” is the wavelength of the used X-ray, “B” is the full width at half maximum of the respective reflex, and “θ_{B}” is the position thereof.

For the tin oxide, the term “nanoparticular” has the meaning that the particle size which is determined according to the Scherrer equation, preferably is below 100 nm. Particularly preferred is a particle size in the range of from 0.5 and 100 nm. Still more preferred, the particle size is below 50 nm. Exceptionally preferred is a particle size range of the tin oxide between 1 and 50 nm.

Also the palladium particles can be present in the before described particle size ranges.

The term “roentgenographically amorphous” has the meaning that by means of wide-angle X-ray scattering analysis no analyzable reflexes are obtained being characteristical for a substance.

The term “roentgenographically amorphous” has also the meaning that the particle sizes of the tin oxide and/or of the palladium can be in the atomic dimension.

The fresh catalysts, that is the catalysts being calcined at 500° C., have tin oxide particle sizes being determined according to the Scherrer method, in general, of from about 1 to 100 nm, in which the particle sizes of the tin oxide can depend on the utilized zeolite. In some cases actually no reflexes of the tin oxide can be detected, so that the tin oxide being present on said catalyst, can be termed as “roentgenographically amorphous”. After aging at a temperature of approximately 700° C., dependent on the used zeolite, no or only a very little agglomeration of the tin oxide particles can be detected. This outlines the very good durability of the catalysts according to the invention.

Surprisingly, the roentgenographically amorphous or nanoparticular form of the tin oxide is maintained for a high loading of the carrier oxide with tin.

Therefore, the catalyst of the present invention differs from the catalysts of the prior art, in particular from the tin oxide-containing catalysts, inter alia thereby that
(a) said catalyst contains tin oxide besides palladium,
(b) said catalyst contains as carrier oxide at least one zeolite,
(c) the zeolite preferably has a silicon/aluminum ratio of >4,
(d) in the manufacture of said catalyst, the tin oxide is contacted with the zeolite in the form of a dissolved or at least partially dissolved precursor, and
(e)) tin oxide and palladium are mutually present in directly topographical proximity on the zeolite.

Other essential differences compared to the catalysts of the prior art are achieved by a relatively high loading of the carrier oxide with tin oxide, by the selection of the weight proportions of the components being contained in the catalyst, by the high dispersity of tin oxide and palladium respectively as well as by the processes for the manufacture of the catalyst which are disclosed above.

The zeolite being coated with tin oxide and palladium has a particular importance for the achievement of a light-off temperature for the carbon monoxide and the hydrocarbons being as low as possible. While the high activity for the activation of hydrocarbons at zeolites being doped with noble metals was already known, it was surprising that the catalyst according to the invention additionally also has an excellent activity with respect to the oxidation of carbon monoxide. Also the extraordinarily good resistance towards sulfur oxide of the exhaust gases of cars is novel for palladium-containing catalysts and could not be expected in said form.

Therefore, the present invention also relates to the use of the catalyst for the removal of harmful substances from exhaust gases of lean combustion engines and exhaust airs.

Furthermore, the present invention also relates to a process for the purification of exhaust gases of lean combustion engines and exhaust airs by using the above disclosed catalyst.

Preferably, said process for the purification of exhaust gases is carried out in a manner that said purification comprises the simultaneous oxidation of hydrocarbons and carbon monoxide as well as the removal of soot by oxidation.

The catalysts can also be run in combination with at least one other catalyst or carbon-particulate filter. Thereby, for example, the carbon-particulate filter can be coated with the catalyst. The combination of the catalyst according to the invention with another catalyst is conceivable (αα) by a sequential arrangement of the different catalysts, (ββ) by the physical mixture of the different catalysts and application onto a common shaped body or (γγ) by application of the different catalysts in the form of layers onto a common shaped body, as well as by any combination thereof.

Preferably, the carbon-particulate filter itself is coated with the oxidation catalyst.

In the following, the manufacture of exemplified catalysts is illustrated and the properties thereof are presented in comparison to the prior art. The fact that this is carried out at hand of concrete examples by specifying concrete values shall in no case be understood as limitation of the specifications which are made in the description and in the claims.

### Catalyst Testing

Activity measurements were carried out in a fully automated catalyst facility with 16 fixed bed reactors made from stainless steel (the inner diameter of an individual reaction chamber was 7 mm) which were run in parallel. The catalysts were tested under conditions being similar to diesel exhaust gas in a continuously operational mode with an oxygen surplus using the following conditions:

| | |
|---|---|
| temperature range: | 120-400° C. |
| exhaust gas composition: | 1500 vppm CO, 100 vppm C₁ (octane), 300 |
| | vppm NO, 10% O₂, 6% H₂O, 10% CO₂, |
| | balance - N₂. |
| gas flow rate: | 45 l/h per catalyst |
| catalyst mass: | 0.125 g. |

The exemplarily produced catalysts were measured as bulk material consisting of zeolite, tin oxide, palladium and optionally binder oxide, promoters and further metals from the platinum group. The application of the washcoat onto a shaped body was set aside. As a rule, a sieve fraction of the samples having particle sizes of from 315-700 μm was used for the measurement of the activity, respectively.

As reference catalysts (CE), a commercial honeycomb shaped oxidation catalyst for exhaust gases from diesel engines was utilized having 3.1 g/l (90 g/ft³) platinum which was mortared and was also used as bulk material for the measurements. The mass of the reference catalyst being used for the measurements was clearly higher compared to the mass of the catalysts according to the invention, what was resulting from that the reference catalyst was diluted by the honeycomb shaped carrier substrate. So, the comparison measurements between the catalysts according to the invention and the reference catalyst were carried out on the basis of approximately the same catalyst (washcoat) mass. The catalysts according to the invention had a significantly lower mass of noble metals than the reference catalyst.

The determination of CO and CO₂ was carried out with ND-IR-analyzers of the company ABB (“Advance Optima” type). The determination of the hydrocarbon was carried out with a FID of the company ABB (“Advance Optima” type). O₂ was determined with a λ-sensor of the company Etas, whereas the determination of NO, NO₂ and NOₓ was carried out with an ultraviolet apparatus of company ABB (“Advance Optima” type).

For the assessment of the catalysts, the T₅₀ values (temperature, where 50% conversion is achieved) were used as criteria for the CO oxidation, and the conversions at 200° C. for the octane oxidation as assessment criteria for the oxidation activity.

The T₅₀ values and octane conversions at 200° C. for the catalysts after the different aging processes (thermally aging, sulfur aging, hydrothermally aging) are summarized in the Tables 2 to 3.

### Sulfur Aging

The term “sulfur aging (also sulfur tolerance or sulfur resistance)” describes the capability of an oxidation catalyst of oxidizing CO and HC being contained in the exhaust gas to CO₂ and H₂O, also after the influence of sulfur oxides (SOₓ).

The sulfur aging was carried out in a 48-folded parallel reactor using the following conditions:

| | |
|---|---|
| temperature: | 350° C. |
| duration: | 24 hours |
| gas composition: | 150 vppm SO₂, 5% H₂O, balance - synthetic |
| | air. |
| gas flow rate: | 10 l/h per catalyst |
| catalyst mass: | 0.125 g. |

After the aging for 24 hours, the feeding of the SO₂ was terminated and the catalysts were cooled down in synthetic air.

### Thermally Aging and Hydrothermally Aging

The thermally aging of the catalysts was carried out in air in a muffle furnace at a temperature of 700° C. in air. Thereby, the catalysts were kept for 16 hours at this temperature and were then cooled down to room temperature.

For the hydrothermally aging, the catalysts were stored in a muffle furnace at a temperature of 800° C., whereby during said storing air containing water in an amount of 10% by volume was inserted into said muffle furnace.

### EXAMPLES

### Example 1 (B1)

For the manufacture of the catalytically active material, 2.5 g zeolite (CP 814E, company Zeolyst) were provided.

1755 μl of an aqueous 1.2 molar solution consisting of tin oxalate and 30% nitric acid (HNO₃) were mixed with 147 μl of an aqueous HNO₃-containing 1.6 molar palladium nitrate solution [Pd(NO₃)₂ solution], and the solution was diluted with 2098 μl water. At first, the zeolite was impregnated with 4000 μl of said tin- and palladium-containing salt solution, and subsequently stored in a drying oven for 16 h at 80° C. Subsequently, the material was calcined for 2 hours at 500° C. in air in a muffle furnace (termed as “fresh”). Additionally, a portion thereof was calcinined for 16 hours at 700° C. in air. Another portion of the freshly prepared sample was hydrothermally aged for 10 h at 800° C.

The resulting loading of the zeolite catalyst was 1% by weight palladium and 10% by weight tin.

### Examples 2 to 4 (B2-B4)

The catalysts were manufactured analogously to Example 1, whereby the composition of the active components was varied.

In Table 1, the compositions of the respective zeolite catalysts are specified on the basis of % by weight, whereby said specifications relate to the elementary form of the palladium, of the tin and of the promoters.

### Examples 5-7 (B5-B7)

The catalysts were manufactured analogously to Example 1, whereby the zeolite (Zeocat PB/H) of the company Zeochem was employed and the composition of the active components was varied.

In Table 1, the compositions of the zeolite catalysts are specified according to Examples B5 to B7.

### Example 8 to 9 (B8-B9)

The catalysts were manufactured analogously to Example 1, whereby the zeolite (H-BEA25) of the company Süd-Chemie was employed in combination with a binder oxide (Puralox SCFa 140) of the company Sasol, and the composition of the active components was varied.

In Table 1, the compositions of the formulations are specified according to Examples B8 to B9.

### Comparison Example 1 (CE1)

For the comparison, an oxidation catalyst based on platinum having a platinum content of 3.1 μl (90 g/ft³) (“reference catalyst”) was utilized.

TABLE 1
Compositions of the catalysts based on different zeolites and zeolite/binder oxides with palladium
and tin oxide as active component which were doped with different promoters in different quantities

| | | | active component and promoters [% by weight based | | | | |
|---|---|---|---|---|---|---|---|
| | | | on zeolite respectively zeolite + binder oxide] | | | | |
| Example | zeolite | binder oxide | Pd | Sn | In | Ga | Fe |
| B1 | CP 814E Zeolite (Zeolyst) | none | 1 | 10 | | | |
| B2 | CP 814E Zeolite (Zeolyst) | none | 1 | 10 | 0.5 | | |
| B3 | CP 814E Zeolite (Zeolyst) | none | 1 | 20 | | 0.5 | |
| B4 | CP 814E Zeolite (Zeolyst) | none | 1 | 10 | | | 0.1 |
| B5 | Zeocat PB/H (Zeochem) | none | 1 | 5 | | 0.5 | |
| B6 | Zeocat PB/H (Zeochem) | none | 1 | 10 | 0.5 | | |
| B7 | Zeocat PB/H (Zeochem) | none | 1 | 10 | | | 0.5 |
| B8 | H-BEA25 (SüdChemie) [50%] | Puralox SCFa 140 | 2 | 20 | | | |
| | | (Sasol) [50%] | | | | | |
| B9 | H-BEA25 (SüdChemie) [50%] | Puralox SCFa 140 | 2 | 20 | | | 1 |
| | | (Sasol) [50%] | | | | | |

TABLE 2
Results of the catalytically testing of the CO oxidation at
the catalysts according to the different types of aging

| | | T₅₀ (CO) [° C.] | | |
|---|---|---|---|---|
| | | | | after thermally |
| | mass of | after ther- | after hydro- | aging (700° C., |
| | noble metal | mally aging | thermally aging | 16 hs) followed |
| Exam- | in the reac- | (700° C., | (800° C., | by aging with |
| ple | tor [g] | 16 hs) | 10 hs) | SO₂ |
| B1 | 0.00114 | 155 | | 185 |
| B2 | 0.00114 | 164 | 184 | 185 |
| B3 | 0.00104 | 173 | 186 | 190 |
| B4 | 0.00114 | 173 | 186 | 190 |
| B5 | 0.00118 | 184 | 190 | 186 |
| B6 | 0.00114 | 184 | 188 | 187 |
| B7 | 0.00114 | 192 | | 206 |
| B8 | 0.00208 | 159 | | 177 |
| B9 | 0.00208 | 165 | | 190 |
| CE1 | 0.00250 | 172 | 185 | 189 |

TABLE 3
Results of the catalytically testing of the octane oxidation
at the catalysts according to the different types of aging

| | | octane conversion at 200° C. [%] | | |
|---|---|---|---|---|
| | | | | after thermally |
| | mass of | after ther- | after hydro- | aging (700° C., |
| | noble metal | mally aging | thermally aging | 16 hs) followed |
| Exam- | in the reac- | (700° C., | (800° C., | by aging with |
| ple | tor [g] | 16 hs) | 10 hs) | SO₂ |
| B1 | 0.00114 | 60 | | 53 |
| B2 | 0.00114 | 69 | 55 | 60 |
| B3 | 0.00104 | 59 | 30 | 50 |
| B4 | 0.00114 | 63 | 42 | 61 |
| B5 | 0.00118 | 76 | 48 | 70 |
| B6 | 0.00114 | 60 | 42 | 57 |
| B7 | 0.00114 | 82 | | 81 |
| B8 | 0.00208 | 62 | | 40 |
| B9 | 0.00208 | 69 | | 44 |
| CE1 | 0.00250 | 34 | 26 | 25 |

1. Catalyst containing tin oxide, palladium and a carrier oxide, characterized in that said carrier oxide comprises one or more zeolites.

2. Catalyst as claimed in claim 1, characterized in that said one or more zeolites have a silicon/aluminum ratio of >4, wherein a silicon/aluminum ratio of >7 is particularly preferred.

3. Catalyst as claimed in claim 1 or 2, characterized in that said one or more zeolites are selected from the group consisting of: H ZSM-5, dealuminated Y zeolite, hydrothermally treated Y zeolite, mordenite or zeolite-β, iron-doped ZSM-5, iron-doped Y zeolite, iron-doped mordenite, iron-doped zeolite-β.

4. Catalyst as claimed in any one of the preceding claims, characterized in that said catalyst contains binder oxide based on Al₂O₃, SiO₂, Al₂O₃/SiO₂-mixed oxide, rare earth element oxide-doped Al₂O₃, TiO₂, ZrO₂, BaSO₄, Ce₂O₃, Ce₂O₃/ZrO₂-mixed oxide, Fe₂O₃, Mn₃O₄, as well as mixtures thereof.

5. Catalyst as claimed in any one of the preceding claims, characterized in that the total amount of zeolite based on the total amount of at least one zeolite and binder oxide is from 10-100% by weight, wherein a total amount of from 20-90% by weight is preferred.

6. Catalyst as claimed in any one of the preceding claims, characterized in that said catalyst is doped with one or more elements selected from the group consisting of platinum, rhodium, iridium or ruthenium.

7. Catalyst as claimed in any one of the preceding claims, characterized in that said catalyst is doped with one or more promoters selected from the group consisting of indium oxide, gallium oxide, iron oxide, alkali metal oxide, earth alkali metal oxide and rare earth element oxide.

8. Catalyst as claimed in any one of the preceding claims, characterized in that the amount of tin oxide (calculated as tin) based on the mass ratio relatively to the total amount of zeolite and binder oxides is from 2 to 50% by weight, preferably from 4 to 25% by weight.

9. Catalyst as claimed in any one of the preceding claims, characterized in that the amount of palladium and optionally platinum, rhodium, iridium and ruthenium based on the weight ratios relatively to the total amount of zeolite and binder oxides is from 0.2 to 10% by weight, preferably from 0.5 to 5% by weight.

10. Catalyst as claimed in any one of the preceding claims, characterized in that the mass ratio of tin oxide (calculated as tin) to the sum of the weights of palladium and optionally platinum, rhodium, iridium and ruthenium preferably is in a range of from 2.0:1 to 40:1, more preferred in a range of from 5:1 to 20:1.

11. Catalyst as claimed in any one of claims 6 to 10, characterized in that the weight ratio of palladium to platinum preferably is in a range of from 0.3:1 to 1000:1, more preferred in a range of from 1:1 to 50:1, if platinum is additionally employed to palladium.

12. Catalyst as claimed in any one of claims 6 to 10, characterized in that the weight ratio of palladium to rhodium, ruthenium, iridium or a mixture thereof preferably is in a range of from 2.5:1 to 1000:1, more preferred in a range of from 5:1 to 20:1, if rhodium, ruthenium, iridium or mixtures thereof are employed in place of platinum.

13. Catalyst as claimed in any one of claims 6 to 12, characterized in that the weight ratio of palladium to the sum of the weights of platinum and at least one further metal from the platinum group preferably is from 0.3:1 to 1000:1, more preferred from 1:1 to 50:1, if platinum and at least one further metal of the platinum group are additionally employed to palladium.

14. Catalyst as claimed in any one of claims 7 to 13, characterized in that the weight ratio of the tin oxide (calculated as tin) to the sum of all promoters (calculated as elements) is in a range of from 2:1 to 100:1, more preferred in a range of from 4:1 to 50:1, still more preferred in a range of from 5:1 to 40:1.

15. Catalyst as claimed in any one of the preceding claims, characterized in that said catalyst exists as powder, pellets, extrudate, shaped body or as coated honeycomb body.

16. Process for the manufacture of a catalyst as claimed in any one of claims 1 to 15, characterized in that said process comprises the step (i):
(i) contacting tin compounds and palladium compounds with a carrier oxide, wherein the carrier oxide comprises one or more zeolites.

17. Use of a catalyst as claimed in any one of claims 1 to 15, or of a catalyst manufactured as claimed in claim 16, for the removal of harmful substances from lean combustion engines and exhaust airs.

18. Process for the removal of harmful substances from exhaust gases of lean combustion engines and exhaust airs by using a catalyst as claimed in any one of claims 1 to 15, or of a catalyst manufactured as claimed in claim 16, characterized in that said process comprises the oxidation of carbon monoxide and hydrocarbons as well as the simultaneous removal of sooty particles by oxidation.

19. Process as claimed in claim 18, characterized in that said catalyst is employed as surface coating for carbon-particulate filters.
